(19) United States
(12) Patent Application Publication
(10) Pub. No.: US 2026/0194109 A1
(43) Pub. Date: Jul. 9, 2026

(54) ROLLING BEARING ARRANGEMENT

(71) Applicant: Schaeffler Technologies AG & Co. KG, Herzogenaurach (DE)

(72) Inventors: KLAUS ZIMMERMANN, Oberthulba (DE); Huimin HAN, Shanghai (CN)

(73) Assignee: Schaeffler Technologies AG & Co. KG, Herzogenaurach (DE)

(21) Appl. No.: 18/863,656

(22) PCT Filed: Mar. 13, 2023
(86) PCT No.: PCT/DE2023/100184

§ 371 Date: Nov. 7, 2024

(30) Foreign Application Priority Data
May 9, 2022 (DE) 10 2022 111 438.4

(51) Int. Cl. F16C 35/073; F16C 19/38

(52) U.S. Cl. CPC F16C 35/073; F16C 19/38; F16C 2226/16

(57) ABSTRACT

A rolling bearing arrangement includes a rolling bearing arranged on a clamping sleeve, wherein the rolling bearing is axially secured at least on one side by means of a slotted nut. An annular safety washer is arranged axially between the slotted nut and the rolling bearing, with which a rotation lock is formed between the clamping sleeve and the slotted nut. The annular safety washer has a plurality of spacer elements formed as a single piece via a press-fit with the safety washer and acting in the axial direction, and which are arranged spaced apart from one another in the circumferential direction.

### CROSS-REFERENCE TO RELATED APPLICATIONS

This application is the U.S. National Phase of PCT Appln. No. PCT/DE2023/100184 filed Mar. 13, 2023, which claims priority to DE 10 2022 111 438.4 filed May 9, 2022, the entire disclosures of which are incorporated by reference herein.

### TECHNICAL FIELD

The present disclosure relates to a rolling bearing arrangement comprising a rolling bearing arranged on a clamping sleeve, wherein the rolling bearing is axially secured at least on one side by means of a slotted nut and a ring-shaped locking washer is arranged axially between the slotted nut and the rolling bearing, by means of which a rotation lock is formed between the clamping sleeve and the slotted nut.

### BACKGROUND

Rolling bearings can be used in particular to enable rotary movements with the lowest possible frictional losses. Rolling bearings can be used in particular to affix and/or mount axles and clamping sleeves, wherein, depending on the design, they absorb radial and/or axial forces and simultaneously enable the rotation of the clamping sleeve or the components mounted on an axle in this way. For this purpose, rolling elements are arranged so as to roll between an inner ring and an outer ring of the rolling bearing. Between these three main components-inner ring, outer ring and the rolling elements-it is usually mainly rolling friction that occurs within the rolling bearing. Since the rolling elements in the inner and outer ring can preferably roll on hardened steel surfaces with optimized lubrication, the rolling friction of such bearings is relatively low.

There are a number of problems associated with the contamination of rolling bearings. Generally speaking, it is attempted in this regard to solve the problem by using sealing rings with multiple sealing lips. The sealing of rolling bearings with seals or diaphragms is already an established method to prevent the ingress of fluids such as oil, water or even dirt particles. Such bearing concepts are often used in combination with a lifetime lubrication using grease.

Agricultural applications, for example with regard to agricultural machinery or vehicles such as tractors, pose particular challenges for such bearings. Due to the surfaces that such a vehicle has to drive on, such applications have very challenging load profiles for rolling bearings. At the same time, the ingress of contaminants into the bearing can damage the bearing and lead to premature functional failure.

A particular problem here is that tilting of the clamping sleeve and/or axial misalignment between the bearing inner ring and bearing outer ring or incorrect assembly can lead to a collision between the locking washer and the seal of the bearing, which impairs or even completely negates its sealing effect.

### SUMMARY

It is therefore the object of the disclosure to provide a rolling bearing arrangement which provides for an improved and operationally reliable sealing of the rolling bearing.

This object is achieved by a rolling bearing arrangement comprising a rolling bearing arranged on a clamping sleeve, wherein the rolling bearing is axially secured at least on one side by means of a slotted nut and a ring-shaped locking washer is arranged axially between the slotted nut and the rolling bearing, by means of which a rotation lock is formed between the clamping sleeve and the slotted nut, wherein the ring-shaped locking washer has a plurality of spacer elements monolithically formed via a press-fit with the locking washer and acting in the axial direction, and which are arranged spaced apart from one another in the circumferential direction.

This has the advantage that a clamping sleeve can be used to clamp a rolling bearing, in particular a sealed one, irrespective of its location. The spacer elements thus form an axial flat surface between the locking washer and the rolling bearing, in particular the sealed tapered rolling bearing inner ring, so that in the event of tilting of the clamping sleeve and/or axial misalignment between the rolling bearing inner ring and the rolling bearing outer ring and/or incorrect assembly, the risk of collision between the locking washer and the seal of the sealed rolling bearing can be excluded. This prevents damage to the seal and the resulting reduction in sealing efficiency, which drastically reduces the risk of premature rolling bearing failure.

The spacer elements spaced apart in the circumferential direction can further define a gap between the locking washer and, for example, the sealed tapered rolling bearing inner ring, through which, for example, old and used grease can escape from the seal of the rolling bearing in the event of relubrication.

It is preferred that the axial extension of the spacer elements from the ring-shaped locking washer corresponds approximately to the axial thickness of the locking washer, so that the axial distance between the slotted nut and the rolling bearing is approximately doubled compared to a locking washer without spacer elements.

For the purposes of this application, a monolithic formation via a press-fit is to be understood as a plastic deformation due to a material displacement within the locking washer.

The individual elements of the claimed subject matter of the disclosure are explained in this disclosure, after which advantageous embodiments of the subject matter of the disclosure are described.

A rolling bearing can be of single-row or multi-row design. The rolling bearing is preferably configured as a double-row barrel rolling bearing.

The rolling bearing can comprise an inner ring. The inner ring can in particular connect the clamping sleeve accommodating the rolling bearings to the rolling bearing or the rolling elements. In particular, the clamping sleeve can be connected to the side of the lateral surface of the inner ring facing the clamping sleeve, wherein the rolling elements of the rolling bearing roll on the inner ring raceway opposite this lateral surface. The inner ring can be made of a metallic and/or ceramic material. In principle, it is conceivable to design the inner ring in one piece or in multiple pieces, in particular in two pieces.

The inner ring can have an inner ring groove. In particular, a cover washer, sealing washer and/or seal can be arranged in an inner ring groove, in particular in a force-fitting and/or form-fitting manner. The inner ring groove is preferably formed as a circumferential groove in the inner ring.

The rolling bearing can also have an outer ring. The outer ring can, in particular, connect the bearing arrangement accommodating the rolling bearings to the rolling bearing or the rolling elements. In particular, the bearing arrangement can be connected to the side of the lateral surface of the outer ring facing the bearing arrangement, wherein the rolling elements of the rolling bearing roll on the outer ring raceway opposite this lateral surface. The outer ring can be made of a metallic and/or ceramic material. In principle, it is conceivable to design the outer ring in one piece or in multiple pieces, in particular in two pieces.

The rolling bearing further comprises rolling elements. Depending on the type of rolling bearing, the rolling elements have the shape of a ball or a roller. They roll on the raceways of the rolling bearing and have the task of transmitting the force acting on a radial rolling bearing from the outer ring to the inner ring and vice versa. In an axial rolling bearing, the rolling elements transmit the forces acting on the axial rolling bearing between the running discs. Roller-like rolling elements are also referred to as roller rolling elements and spherical rolling elements as bearing balls.

Roller-like rolling elements can be selected, for example, from the group of symmetrical spherical rollers, asymmetrical spherical rollers, cylindrical rollers, needle rollers and/or tapered rollers.

Rolling elements can be guided and spaced apart in a cage or by rolling element spacers. In principle, it is also conceivable to design a rolling bearing without a cage, which is also referred to as a full-complement rolling bearing. In full-complement rolling bearings, adjacent rolling elements can contact one another.

A rolling bearing can have a cage, wherein the cage guides the rolling elements. The cage is designed in such a way that the rolling element balls and/or the rolling element rollers are spaced apart from one another so that, for example, the friction and heat development of the rolling elements is kept as low as possible. Furthermore, the cage keeps the rolling element balls and/or rolling element rollers at a fixed distance from one another during rolling, as a result of which an even load distribution can be achieved. The cage can be made in one piece or in multiple pieces.

The rolling elements can roll within the rolling bearing, in particular on the inner ring raceway of the inner ring. For this purpose, the surface of the inner ring raceway can advantageously be designed to be abrasion-resistant, for example by means of a corresponding surface treatment method and/or by applying a corresponding additional layer of material.

The inner ring raceway can be designed to be planar or profiled. A profiled design of the inner ring raceway can be used, for example, to guide the rolling elements on the inner ring raceway. On the other hand, a planar formation of the inner ring raceway can, for example, allow a certain axial displaceability of the rolling elements on the inner ring raceway.

The rolling elements can roll within the rolling bearing, in particular on the outer ring raceway of the outer ring. For this purpose, the surface of the outer ring raceway can advantageously be designed to be abrasion-resistant, for example by means of a corresponding surface treatment method and/or by applying a corresponding additional layer of material.

The outer ring raceway can be designed to be planar or profiled. A profiled design of the outer ring raceway can be used, for example, to guide the rolling elements on the outer ring raceway. On the other hand, a planar formation of the outer ring raceway can, for example, allow a certain axial displaceability of the rolling elements on the outer ring raceway.

A rolling bearing can have at least one seal in order to prevent or reduce the escape of lubricant from the rolling bearing or the ingress of dirt or moisture into the rolling bearing.

According to a preferred embodiment of the disclosure, it can be advantageous for the seal to be formed at least in sections, preferably completely, from an elastic material. It can also be advantageous for the seal to be fixed in a form-fitting manner to the inner ring and/or the outer ring.

According to an advantageous embodiment of the disclosure, the spacer elements can be designed in a point-like manner. The advantage of this design is that it results in the largest possible intermediate spaces between the spacer elements, which can be used, for example, for the flow of lubricating oil or grease According to a further preferred further development of the disclosure, the spacer elements can be designed in the form of annular segments. This allows greater axial forces to be transmitted between the slotted nut and the rolling bearing.

In principle, it is of course also possible to form annular as well as point-like spacer elements together on a locking washer.

In this context, it is also particularly preferred that the number of spacer elements is at least three in order to guarantee a statically determined contact of the locking washer with the rolling bearing.

Furthermore, according to an equally advantageous embodiment of the disclosure, the spacer elements can be designed to be essentially identical, which can result in production-related advantages as well as cost savings.

According to a further particularly preferred embodiment of the disclosure, the spacer elements can be arranged equidistantly over the circumference of the ring-shaped locking washer, so that contact with the rolling bearing can be as uniform as possible.

Furthermore, the disclosure can also be further developed in such a way that at least one means of identification for identifying the locking washer is formed on the ring-shaped locking washer in the circumferential direction between two adjacent spacer elements. In particular, the means of identification can be product-related and/or production-related information that allows for automated handling and assembly of the locking washer, for example by a robot.

In an equally preferred embodiment of the disclosure, the ring-shaped locking washer can have a plurality of tabs on its radially outer circumference, which are plastically pivotable in the axial direction for the purpose of achieving a form-fit in the circumferential direction with the slotted nut. It can also be advantageous to further develop the disclosure in such a way that the ring-shaped locking washer has a tab on its radially inner circumference, which engages in a form-fitting manner in the clamping sleeve in the circumferential direction.

The advantage that can be achieved in this way is that the slotted nut can be secured in a form-fitting manner with respect to the clamping sleeve in the circumferential direction in a way that is both secure and simple to implement with respect to the assembly, whereby, for example, a defined preload on the rolling bearing can be stably maintained.

According to a further preferred embodiment of the subject matter of the disclosure, the clamping sleeve can have a conically formed lateral surface, wherein an inner ring of the rolling bearing has a correspondingly conical radially inner lateral surface, so that the slotted nut fixes the inner ring against the clamping sleeve axially without play via the locking washer.

Finally, the disclosure can also be advantageously designed in such a way that the slotted nut is connected to the clamping sleeve via a thread, whereby the preload force on the rolling bearing can be adjusted particularly well.

### BRIEF DESCRIPTION OF THE DRAWINGS

The disclosure is explained in more detail below with reference to figures without limiting the general concept of the disclosure.

In the figures:

FIG. 1 shows a rolling bearing arrangement in a schematic axial sectional view,

FIG. 2 shows a first embodiment of a locking washer in an exposed perspective view,

FIG. 3 shows a second embodiment of a locking washer in an exposed perspective view.

### DETAILED DESCRIPTION

The figure shows a rolling bearing arrangement 1 comprising a rolling bearing 3 arranged on a clamping sleeve 2. The rolling bearing 1 shown in the exemplary embodiment is configured as a double-row barrel rolling bearing with barrel-shaped rolling elements 16. These roll between the inner ring 9 and the outer ring 17. The rolling bearing 3 is axially secured on one side by means of a slotted nut 4, which is connected to the clamping sleeve 2 via a thread 7.

A ring-shaped locking washer 5 is arranged axially between the slotted nut 4 and the rolling bearing 3, by means of which a rotation lock is formed between the clamping sleeve 2 and the slotted nut 4 in order to mechanically secure an axial preload defined by the rotation of the slotted nut 4 relative to the clamping sleeve 2 through the slotted nut 4 onto the rolling bearing 3. The clamping sleeve 2 has a conically formed lateral surface 6, wherein an inner ring 9 of the rolling bearing 3 has a correspondingly conical radially inner lateral surface 10, so that the slotted nut 4 fixes the inner ring 9 against the clamping sleeve 2 axially without play via the locking washer 5.

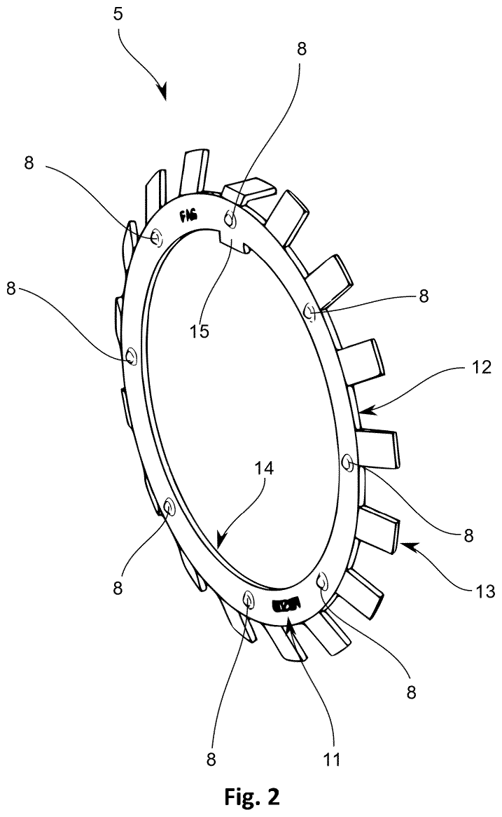

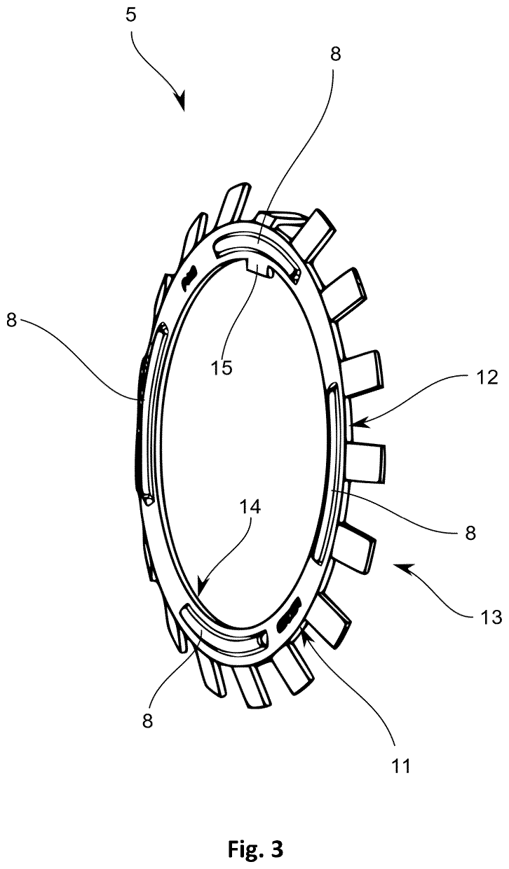

The ring-shaped locking washer 5 further has a plurality of spacer elements 8 monolithically formed via a press-fit with the locking washer 5 and acting in the axial direction, and which are arranged spaced apart from one another in the circumferential direction. This can also be clearly seen from the synopsis of FIGS. 2-3. In particular, this does not produce a circumferentially closed, annular contact between the locking washer 5 and the rolling bearing 3, but rather contact points or contact lines circumferentially spaced apart from one another.

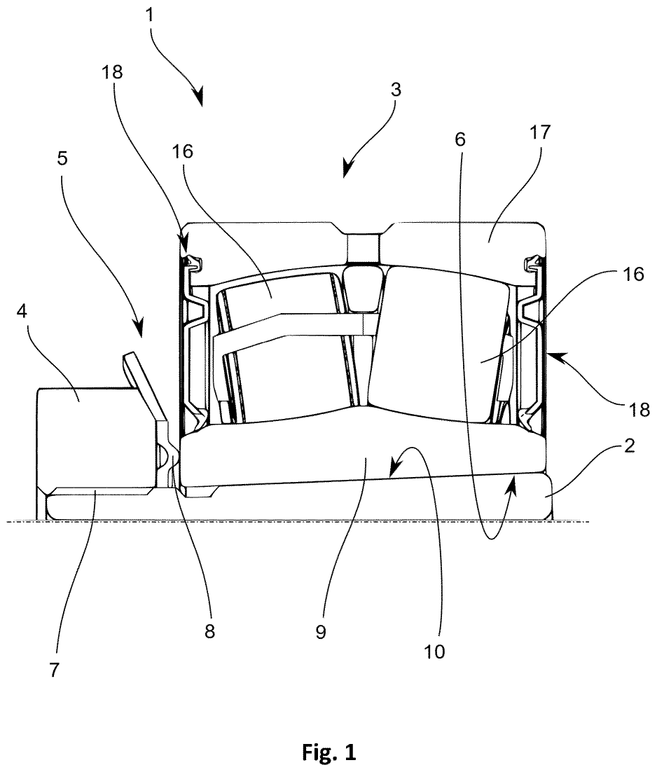

As can be seen from FIG. 1, the spacer elements 8 increase the axial distance between the slotted nut 4 and the inner ring 9 of the rolling bearing 3, which reduces the risk of unintentional contact between the seal 18 of the rolling bearing 3 and the locking washer 5 when the clamping sleeve 2 is bent.

FIG. 2 shows that the spacer elements 8 can be designed in a point-like manner or, as shown in FIG. 3, also in the form of annular segments. The spacer elements 8 are designed to be essentially identical in each case and are arranged equidistantly over the circumference of the ring-shaped locking washer 5.

FIGS. 2-3 further show that at least one means of identification 11 for identifying the locking washer 5 is formed on the ring-shaped locking washer 5 in the circumferential direction between two adjacent spacer elements 8.

The ring-shaped locking washer 5 has a plurality of tabs 13 on its radially outer circumference 12, which are plastically pivotable in the axial direction for the purpose of achieving a form-fit in the circumferential direction with the slotted nut 4, which can also be seen from the synopsis of FIGS. 2-3 with FIG. 1. The ring-shaped locking washer 5 has a tab 15 on its radially inner circumference 14, which engages in a form-fitting manner in the clamping sleeve 2 in the circumferential direction.

The disclosure is not limited to the embodiments shown in the drawings. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### List of Reference Signs

1 Rolling bearing arrangement
2 Clamping sleeve
3 Rolling bearing
4 Slotted nut
5 Locking washer
6 Lateral surface
7 Thread
8 Spacer element
9 Inner ring
10 Lateral surface
11 Means of identification
12 Circumference
13 Tabs
14 Circumference
15 Tab
16 Rolling element
17 Outer ring
18 Seal

1. A rolling bearing arrangement comprising a rolling bearing arranged on a clamping sleeve, wherein the rolling bearing is axially secured at least on one side by a slotted nut and a ring-shaped locking washer is arranged axially between the slotted nut and the rolling bearing, by means of which a rotation lock is formed between the clamping sleeve and the slotted nut,
wherein the ring-shaped locking washer has a plurality of spacer elements monolithically formed via a press-fit with the locking washer and acting in the axial direction, and which are arranged spaced apart from one another in a circumferential direction.

2. The rolling bearing arrangement according to claim 1, wherein:
the spacer elements are designed in a point-like manner.

3. The rolling bearing arrangement according to claim 1, wherein:
the spacer elements are designed in the form of annular segments.

4. The rolling bearing arrangement according to claim 1, wherein:
the spacer elements are designed to be identical.

5. The rolling bearing arrangement according to claim 1, wherein:
the spacer elements are arranged equidistantly over a circumference of the ring-shaped locking washer.

6. The rolling bearing arrangement according to claim 1, wherein:
at least one means of identification for identifying the locking washer is formed on the ring-shaped locking washer in the circumferential direction between two adjacent spacer elements.

7. The rolling bearing arrangement according to claim 1, wherein:
the ring-shaped locking washer has a plurality of tabs on its radially outer circumference, which are plastically pivotable in the axial direction for the purpose of achieving a form-fit in the circumferential direction with the slotted nut.

8. The rolling bearing arrangement according to claim 1, wherein:
the ring-shaped locking washer has a tab on its radially inner circumference, which engages in a form-fitting manner in the clamping sleeve in the circumferential direction.

9. The rolling bearing arrangement according to claim 1, wherein:
the clamping sleeve has a conically formed lateral surface, wherein an inner ring of the rolling bearing has a correspondingly conical radially inner lateral surface, so that the slotted nut fixes the inner ring against the clamping sleeve axially without play via the locking washer.

10. The rolling bearing arrangement according to claim 1, wherein:
the slotted nut is connected to the clamping sleeve via a thread.
